(19) United States
(12) Patent Application Publication
(10) Pub. No.: US 2016/0316290 A1
(43) Pub. Date: Oct. 27, 2016

(54) DUAL-BATTERY CELL BLUETOOTH EARPHONE SET

(71) Applicant: WEN HONG SHEN, Taipei (TW)

(72) Inventor: WEN HONG SHEN, Taipei (TW)

(21) Appl. No.: 14/691,587

(22) Filed: Apr. 21, 2015

(51) Int. Cl. H04R 1/10

(52) U.S. Cl. CPC H04R 1/1041; H04R 1/1025; H04R 1/1016

(57) ABSTRACT

A dual-battery cell Bluetooth earphone set includes two earphones each including an ear hook for attaching the respective earphone to an ear of a user, a speaker and a battery cell, a control box including a control circuit board for transmitting and receiving Bluetooth signals, a power jack for the connection of a charging cable of a battery charger to charge the battery cell of each earphone and a volume control button for regulating the volume of the output of said speaker of each said earphone, and a power line electrically connecting the earphones and the control box.

### FIELD OF INVENTION

The present invention relates to earphone technology and more particularly, to an earphone set, which facilitates fabrication and operation, gives fewer burdens to the ears of the user, and prolongs the working time of the power supply of the earphone set.

### BACKGROUND

Commercial Bluetooth earphone sets commonly have the Bluetooth module, control module and charging device mounted in the earphones, increasing the weight of the earphones. Further, according to conventional design, each earphone is equipped with an ear hanger or retainer for securing the respective earphone to the user's ear, complicating the fabrication of the earphone and increasing its cost. Further, the volume control and charging operation of conventional Bluetooth earphone sets are also inconvenient. Further, conventional Bluetooth earphone sets have the drawback of short battery life. Increasing the number of battery cells will relatively increase the earphone weight and size, giving more burdens to the user's ears.

### SUMMARY OF THE DESCRIPTION

The present invention has been accomplished under the circumstances in view. It is one object of the present invention to provide a dual-battery cell Bluetooth earphone set, which facilitates fabrication and operation, gives less burden to the ears of the user, and prolongs the working time of the power supply of the earphone set.

To achieve this and other objects of the present invention, a dual-battery cell Bluetooth earphone set comprises two earphones each including an ear hook for attaching the respective earphone to an ear of a user, a speaker and a battery cell, a control box including a control circuit board for transmitting and receiving Bluetooth signals, a power jack for the connection of a charging cable of a battery charger to charge the battery cell of each earphone and a volume control button for regulating the volume of the output of said speaker of each said earphone, and a power line electrically connecting the earphones and the control box.

### BRIEF DESCRIPTION OF THE DRAWINGS

FIG. 1 is an oblique top elevation view of a dual-battery cell Bluetooth earphone set in accordance with a first embodiment of the present invention.

FIG. 2 is a sectional view of one earphone of the dual-battery cell Bluetooth earphone set in accordance with the present invention.

FIG. 3 is an exploded view of the control box of the dual-battery cell Bluetooth earphone set in accordance with the present invention.

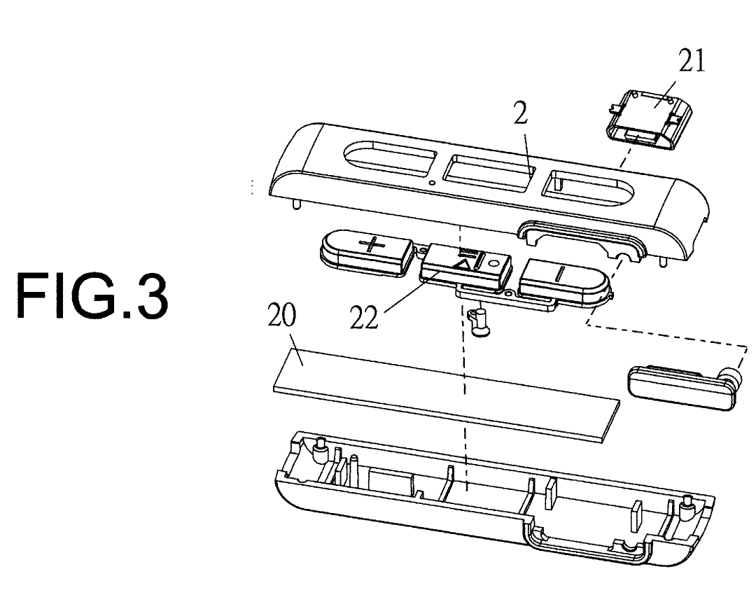

### DETAILED DESCRIPTION

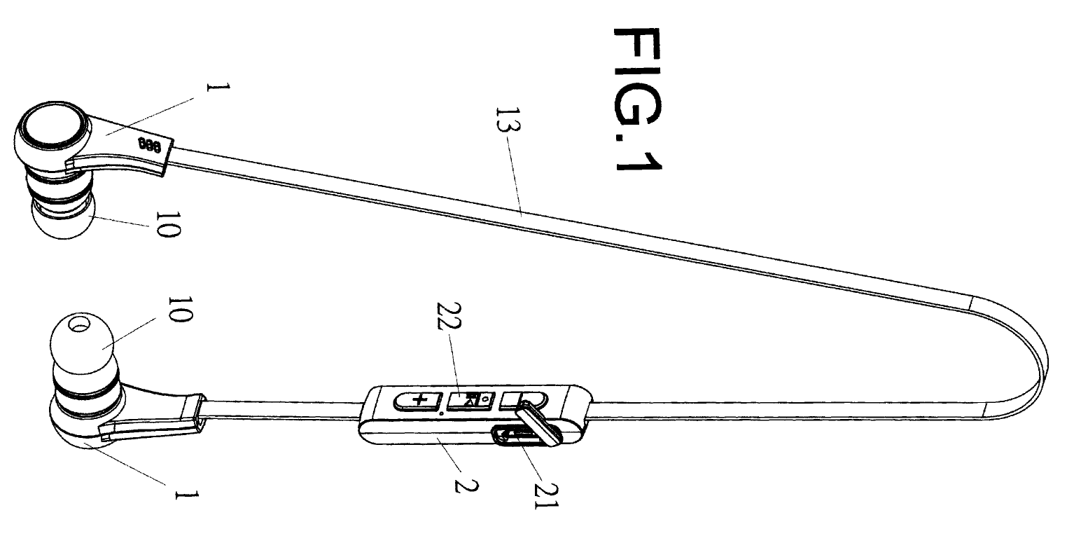

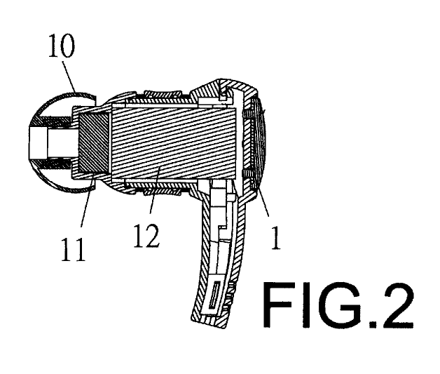

Referring to FIGS. 1 and 2, a dual-battery cell Bluetooth earphone set in accordance with the present invention is shown. The dual-battery cell Bluetooth earphone set comprises two earphones (1), a control box (2), and a power line (13) electrically connecting the earphones (1) and the control box (2) together. Each earphone (1) comprises an ear hook (10) for attaching the earphone (1) to the ear of a user, and a speaker (11) and a battery cell (12) mounted on the inside. The control box (2) comprises a control circuit board (20) for transmitting and receiving Bluetooth signals, a power jack (21) and a volume control button (22) respectively electrically connected to the control circuit board (20).

In use, the user simply needs to insert the ear hooks (10) of the two earphones (1) into the ears of the user. The ear hooks (10) are flexible and elastically deformable. After insertion of the ear hooks (10) of the two earphones (1) into the respective ears of the user, the two earphones (1) are firmly secured to the respective ears of the user. Thus, this design of earphone does not need an extra ear hanger or retainer, facilitating earphone fabrication and cost. Further, each earphone (1) is equipped a respective battery cell (12), prolonging the working time of the power supply of the earphone set. When wishing the charge the battery cells (12), connect the charging cable to the power jack (21) of the control box (2), enabling the control circuit board (20) to charge the battery cells (12). When wishing to adjust the volume of the output sound of the earphones (1), operate the volume control button (22) of the control box (2) to control the operation of the control circuit board (20) in regulating the volume of the output sound of the earphones (1). Unlike the conventional method of regulating the volume of the output sound at the area around the ear, the volume regulation of the invention is convenient. Further, the dual-battery cell Bluetooth earphone set gives fewer burdens to the ears of the user.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A dual-battery cell Bluetooth earphone set, comprising:
two earphones, each said earphone comprising an ear hook for attaching the respective said earphone to an ear of a user, a speaker mounted on the inside, and a battery cell mounted on the inside and electrically connected to said speaker;
a control box comprising a control circuit board for transmitting and receiving Bluetooth signals, a power jack electrically connected to said control circuit board for the connection of a charging cable of a battery charger to charge said battery cell of each said earphone, and a volume control button electrically connected to said control circuit board for regulating the volume of the output of said speaker of each said earphone; and
a power line electrically connecting said earphones and said control box.
